(19) United States
(12) Patent Application Publication
(10) Pub. No.: US 2007/0092976 A1
(43) Pub. Date: Apr. 26, 2007

(54) Continuous emissions monitoring

(75) Inventors: John G. Watson, Reno, NV (US); Tom A. Baldwin, Reno, NV (US); Allan L. Budd, Sun City West, AZ (US)

Correspondence Address: KLARQUIST SPARKMAN, LLP, 121 SW SALMON STREET, SUITE 1600, PORTLAND, OR, 97204, US

(73) Assignee: Board of Regents of the University and College Systems of Nevada

(21) Appl. No.: 11/361,532

(22) Filed: Feb. 23, 2006

Related U.S. Application Data
(60) Provisional application No. 60/724,411, filed on Oct. 6, 2005.

(51) Int. Cl. G01N 1/22

(52) U.S. Cl. 436/181

(57) ABSTRACT

The present disclosure provides methods, systems, and apparatus for continuously monitoring particulates emitted from an emissions source. In a particular embodiment of a disclosed system, the system includes a sample inlet and diluent inlet. The system further includes a mixing chamber in communication with the sample inlet and the diluent inlet. An aerosol sample from the emissions source and diluent from the diluent inlet, received through the respective sample and diluent inlets, are mixed in the mixing chamber. The system includes an ambient dispersion simulator in communication with the mixing chamber. A diluted aerosol sample passes from the mixing chamber to the ambient dispersion simulator, where it is conditioned to produce a conditioned aerosol sample. The conditioned aerosol sample enters a continuous particle detector. The continuous particle detector is configured to make multiple distinct measurements without intervention by a user.

### CROSS REFERENCE TO RELATED APPLICATION

This application claims the benefit of, and incorporates by reference, U.S. Provisional Patent Application No. 60/724,411, filed Oct. 6, 2005.

### FIELD

The present disclosure relates generally to methods, systems, and apparatus for emissions monitoring. More specifically, embodiments of the present disclosure provide such methods, systems, and apparatus for continuously monitoring emissions from emissions sources, including static emissions sources such as smokestacks.

### BACKGROUND

The potentially adverse human health effects of particulates in the atmosphere are of increasing concern. For example, it has been shown that, while larger particulates are filtered out by the human respiratory tract, smaller particles tend to enter the lungs, possible causing allergies and disease.

Emissions from combustion sources, or other industrial sources, contribute a significant amount of particulate matter to the atmosphere. Although governmental agencies have established air quality standards and limits on particulate emissions, there are problems in determining compliance with such standards and limits.

For example, tests typically used to measure particulates emitted from static sources give results that do not accurately reflect, or correlate with, ambient data. Current EPA methods, such as methods 5, 201, 201A, and 202, use a hot filter and a series of cold impingers to measure filterable and condensable particulates, respectively. This approach has been shown to significantly overestimate the amount of emitted particulates, such as by collecting gaseous, as well as condensable, components in the impingers. A study by Wein et al. found that EPA Method 202 may overestimate aerosol condensable mass by a factor of twenty. Wein et. al, PM2.5 Specification Profiles and Emissions Factors from Petroluem Industry Gas-Fired Sources, International Emission Inventor Conference, “One Atmosphere, One Inventory, Many Challenges,” May 1-3, Denver Colo. (2001). On the other hand, fine particles often form after an emissions plume interacts with the atmosphere, and thus direct tests of stack emissions may underestimate the amount of fine particles produced by static emissions sources. Accordingly, such tests may not accurately reflect the particulates produced by the interaction of the emissions plume with the atmosphere, that is, the samples from the stack may not adequately correlate to the atmospheric particulates contributed by the emissions source. Therefore, typical particulate tests may not accurately measure particulate emissions from static sources, thus making it difficult to predict the attendant consequences of such airborne particulates, such as adverse health effects.

It has been recognized that the interaction of an emissions plume with the atmosphere changes the nature of the particulates in the plume. For example, upon leaving the emission source, the plume mixes with the atmosphere, quickly cools, and undergoes physical or chemical changes. A fundamental physical change that typically occurs is a change in the size, or size distribution, of the particles in the aerosol. Such changes in size may occur through processes such as agglomeration, coagulation, condensation, adsorption, and nucleation.

Dilution sampling represents one attempt to replicate such processes in particulate measurement and may provide a number of advantages. For example, dilution sampling may more closely approximate the actual interaction of emissions with the atmosphere, potentially providing more accurate data. In addition, dilution sampling may allow more sensitive detection instruments to be used. Despite their advantages, dilution methods do present some drawbacks.

One such drawback is that typical dilution methods use filters that must be manually retrieved and analyzed, or are otherwise unsuitable for continuous use. Accordingly, such methods are not generally suitable for commercial application, at least partially due to the expense and inconvenience associated with manual testing.

Certain testing methods used for ambient air allow for continuous monitoring. For example, beta attenuation monitors employ beta radiation to determine the mass of a sample deposited on a section of sample tape. When the section of sample tape is no longer useable, the instrument advances the tape to a clean section. Typically supplied in rolls, the tape can last for several weeks before needing to be changed. However, continuous monitoring methods are typically unsuitable for static emission sources due to the concentrated nature and, in certain circumstances, high water content of the emissions.

### SUMMARY

In various embodiments, the present disclosure provides methods, systems, and apparatus for continuously monitoring particulates emitted from an emissions source, including static and mobile sources. In particular examples, the emissions source is a smokestack. Particular embodiments provide for the simultaneous measurement of a plurality of particle sizes, or ranges of particle sizes. At least some of the disclosed subject matter is more cost effective, accurate, or convenient to use compared to typical methods of measuring particulates, such as methods typically used to measure emissions from static sources.

The availability of real-time, easily obtained, particulate emissions data may lead to new paradigms in emissions regulation. For example, the present disclosure may enable a market for trading particulate emissions to emerge, similar to existing markets for trading greenhouse gas emissions. The present disclosure may also enable adverse health effects from airborne particulates to be better mitigated by providing more accurate data regarding particulate emissions.

Certain embodiments of the present disclosure provide systems that can be used to continuously monitor particulate emissions from an emissions source, such as a static emissions source or a mobile emissions source. The systems include a sample inlet that obtains an aerosol sample from the emissions source. The systems also include a diluent inlet in communication with a source of diluent, such as ambient air or a source of gas, such as a source of compressed gas.

In certain embodiments, the diluent is filtered, such as by filters that remove particles, chemicals, or gasses from the diluent. In a particular implementation, the diluent is filtered though a high efficiency particle arrestor (HEPA) filter and a filter containing activated carbon.

The systems further include a mixing chamber where streams of diluent and aerosol sample are mixed. The streams can be mixed before the mixing chamber or in the mixing chamber itself. In a particular embodiment, the mixing chamber includes an eduction system, such as a system where a stream of diluent draws aerosol sample from an aerosol sample stream. In another embodiment, a means of creating turbulence in the diluent or aerosol sample streams, such as a perforated disc or cone, is introduced into the apparatus. In a particular embodiment, the mixing chamber is an open chamber where the diluent and aerosol sample streams are allowed to mix after being combined.

Certain embodiments of the disclosed systems include a flow controller in communication with the diluent stream. The flow controller may be used to control the amount of diluent combined with the aerosol sample, thus controlling how much the aerosol sample is diluted. In particular implementations, the dilution ratio of diluent to sample is from at least about 15:1 to at least about 100:1, such as from at least about 20:1 to at least about 100:1, such as from at least about 20:1 to at least about 50:1. In a more particular implementation, the dilution ratio is about 20:1.

Systems according to the present disclosure, in certain embodiments, include a particle separator, such as a cyclone, intermediate the stream of aerosol sample and the mixing chamber. The particle separator separates particles of a certain size, such as particles above a certain size, such as particles larger than 10 μm, from the sample stream. Separation of such larger particles may reduce maintenance on the systems.

In yet further embodiments, a valve is located intermediate, and in communication with, the mixing device and the particle separator. The valve is in further communication with a gas source, such as compressed gas or pumped air. The valve may be selectively positioned between a first position where the valve allows flow between the particle separator and the mixing device to a second position where the valve allows flow between the particle separator and the gas source. When flow is established with the gas source, the gas source can be used to remove particles from the particle separator, such as by blowing the particles back into the emissions source.

The disclosed systems also contain an ambient, or atmospheric, dispersion simulator. After the diluent and aerosol sample are mixed to form a diluted aerosol sample, the diluted aerosol sample is passed into the ambient dispersion simulator. The ambient dispersion simulator may be a separate component from the mixing chamber, or the mixing chamber may be integral with the ambient dispersion simulator.

The ambient dispersion simulator conditions the diluted aerosol sample to produce a conditioned aerosol sample that is similar in composition to an aerosol produced by the interaction of an emissions plume from the emissions source with the atmosphere.

In particular implementations, the ambient dispersion simulator is a holding tank in which the diluted aerosol sample is held for a period of time before being passed to a detector. In more particular implementations, the time the diluted aerosol sample is retained in the aging tank is at least about 10 seconds, such as at least about 15 seconds, such as at least about 20 seconds. In further implementations, the time spent by the diluted aerosol sample in the aging tank is from about 10 seconds to about 20 minutes, such as from about 10 seconds to about one minute, such as from about 15 seconds to about 30 seconds.

The disclosed systems also contain a detector to detect particles in the conditioned aerosol sample. The detector is configured to continuously monitor particulates in the conditioned aerosol sample. That is, the detector is configured to take multiple measurements without requiring manual intervention. In particular embodiments, the detector is a beta attenuation monitor or a tapered element oscillating microbalance.

In certain embodiments the detector is configured to separately continuously monitor a plurality of particles sizes, or particles size ranges, such as fine particles and coarse particles, such as measuring PM_{2.5} and PM₁₀. In a particular implementation, the detector is a beta attenuation monitor using a virtual impactor to separate fine particles from coarse particles, the fine and coarse particles being measured by separate sensors in the detector. In another particular implementation, fine and coarse particles are separated using a cyclone.

In further embodiments, the systems include multiple detectors, each detector configured to monitor a plurality of particle sizes, or range of particle sizes, such as fine particles and coarse particles, such as measuring PM_{2.5} and PM₁₀. A particle separator is interposed between the ambient dispersion simulator and the multiple detectors. The particle separator separates the conditioned aerosol sample into a first stream at least substantially comprising particles of a first size, or size range, and a second stream at least substantially comprising particles of a second size, or size range. The first stream is directed to a first detector of the multiple detectors and the second stream is directed to a second detector of the multiple detectors.

The disclosed systems include a pump in communication with the detector. The pump directs the conditioned aerosol sample into the detector. The pump may also be in communication with the ambient dispersion simulator, the diluent, particle separators, valve, gas source, mixing device, or other components of the system. In further embodiments, the apparatus includes a plurality of pumps, each pump may be in communication with a discrete portion of the system.

In particular embodiments, the systems include a total flow meter to measure total flow through the system. The total flow meter may be in communication with the pump.

The disclosed systems include a controller. The controller is in communication with the detector and, optionally, the flow controller, the pump, the total flow meter, or the valve. When the systems are appropriately configured, the controller may be in communication with a number of sensors, such as pressure, temperature, humidity, and flow sensors.

The controller is configured to output data. The controller may output data locally, such as on a screen, or may communicate the data to a remote location, such as over a network. In certain embodiments, the data is provided directly to a regulatory agency or to the operator of the emissions source, such as by integration into the control system of the emissions source. The controller may also be used to control operating parameters of the system. Such control may be automatic, such as based on a protocol running on the controller, or in response to a command from a user.

Particular embodiments of the systems include a diluent analyzer. The diluent analyzer may be used to measure the dilution ratio of the diluted aerosol sample. In a particular implementation, the dilution sampler measures the concentration of a component of the aerosol sample, such as CO₂, at a first location prior to the mixing chamber and at a second location downstream from the mixing chamber, such as downstream from the ambient dispersion simulator. The ratio of the gas concentration at the first and second locations may be used to determine the dilution ratio of the diluted aerosol sample.

Certain embodiments of the systems provide a manual sampling port. The manual sampling port allows samples of the conditioned aerosol sample to be manually taken from the system. For example, manual samples may be tested by a standard method in order to confirm proper operation of the system.

The system, or components thereof, in certain embodiments, form an apparatus enclosed in a housing. The housing may be a weatherized housing capable of substantially operating in exposed setting, such as mounted proximate an emissions source. In a particular implementation, all of the components of the system are included in the housing. In further implementations, certain components of the system, such as the controller, are located externally to, and optionally remotely from, the housing. For example, the controller may be in communication with the apparatus through a communication link, such as through an Ethernet connection, a buss, or a network.

In further embodiments, the apparatus is subdivided into a plurality of compartments. In a particular implementation, the mixing chamber and optionally the particle separator, valve, and gas source are located in a first compartment. The ambient dispersion simulator, detector, controller, and optionally the diluent analyzers, total flow meter, and manual sampling port are located in a second compartment. The pump is located in a third compartment.

The apparatus may optionally be temperature controlled. However, in other embodiments, the apparatus is not temperature controlled. When temperature controlled, the apparatus overall may be heated or cooled or certain compartments may be independently heated or cooled. For example, the first compartment may be heated to a first temperature, the first temperature being higher than ambient temperature, and the second compartment may be maintained at a second temperature, the second temperature being about ambient temperature.

The present disclosure also provides methods for monitoring particulate emissions from an emissions source, including mobile and static emissions sources. According to the methods, an aerosol sample is obtained from an emissions source. The aerosol sample is diluted with diluent to produce a diluted aerosol sample. The diluted aerosol sample is passed through an ambient dispersion simulator to provide a conditioned aerosol sample. In the ambient dispersion simulator, the diluted aerosol sample undergoes chemical or physical changes similar to chemical or physical changes that occur when an emissions plume from the emissions source interacts with the atmosphere. The conditioned aerosol sample is passed from the ambient dispersion simulator into a detector. The quantity of particles of a certain size, or size range, in the diluted aerosol sample is continuously monitored.

In further embodiments, the particles in the diluted aerosol sample are continuously monitored. Embodiments of the disclosed methods may also include, prior to measuring the particulates in the conditioned sample, allowing particles in the conditioned aerosol sample to accumulate on sample media. A plurality of measurements are made without removing the sample media from the detector.

The methods may optionally include the step of, prior to diluting the aerosol sample, separating particles larger than a certain size or range from the aerosol sample.

In further embodiments of the disclosed methods, the diluted aerosol sample is retained in the atmospheric simulator for at least about ten seconds. The diluted aerosol sample, in certain embodiments, is diluted to a ratio of diluent to sample of at least about 20:1.

Particular embodiments of the disclosed methods separate the conditioned aerosol stream into first and second aerosol streams. The first aerosol stream at least substantially comprises particles of a first size, or size range, and the second aerosol stream at least substantially comprises particles of a second size, or size range, the second size or range being larger than the first size or range. The first aerosol stream is directed into a first detector and the second aerosol stream is directed into a second detector. The particles in the first and second aerosol streams are continuously monitored by the first and second detectors, respectively.

In further embodiments, the conditioned aerosol sample is passed through a particle separator prior to the step of continuously monitoring the quantity of particles of a certain size in the conditioned aerosol sample. Particles of a first size or size range at least substantially pass to a first portion of the detector and particles of a second size or size range at least substantially pass to a second portion of the detector. The quantity of particles of the first size or range and the quantity of particles of the second size or range are continuously monitored.

A particular embodiment of the disclosed methods dilutes the aerosol sample by passing the diluted aerosol sample through a mixing chamber.

There are additional features and advantages of the subject matter described herein. They will become apparent as this specification proceeds.

In this regard, it is to be understood that this is a brief summary of varying aspects of the subject matter described herein. The various features described in this section and below for various embodiments may be used in combination or separately. Any particular embodiment need not provide all features noted above, nor solve all problems or address all issues in the prior art noted above.

### BRIEF DESCRIPTION OF THE DRAWINGS

FIG. 1 is a schematic diagram of components of a system for continuously monitoring particulate emissions from an emissions source according to an embodiment of the present disclosure;

FIGS. 2A and 2B are schematic diagrams of mixing systems that may be used in the system of FIG. 1. In particular, FIG. 2A is a schematic diagram of a direct dilution system. FIG. 2B is a schematic diagram of an educator system.

FIG. 3 is a schematic diagram of a beta attenuation detector configured to measure different particle sizes that may be used in the system of FIG. 1.

FIG. 4 is a schematic diagram of a disclosed embodiment of an apparatus for use in continuously monitoring particulate emissions from an emissions source.

FIG. 5 is a schematic diagram illustrating how the components of the apparatus of FIG. 4 may be packaged into a unit.

FIG. 6 is a schematic diagram of a disclosed test system for continuously monitoring emissions from an emissions source.

FIG. 7 is a schematic diagram of a disclosed system for generating samples to be tested using the test system of FIG. 6.

FIG. 8 is a chart of the concentration of PM_{2.5} of a road dust and flyash sample as measured by the test system of FIG. 6 compared to a manual gravimetric method.

FIG. 9 is a chart of the concentration of PM₁₀ of a road dust and flyash sample as measured by the test system of FIG. 6 compared to a manual gravimetric method.

FIG. 10 is a graph of NaCi particle sizes, as measured by a Grimm Particle Size Spectrometer, in a sample used in the test system of FIG. 6.

FIG. 11 is a chart of the concentrations of PM₁₀ and PM_{2.5} of the salt sample of FIG. 10 as measured by the test system of FIG. 6 compared to a manual gravimetric method.

### DETAILED DESCRIPTION

Definitions

Unless otherwise explained, all technical and scientific terms used herein have the same meaning as commonly understood by one of ordinary skill in the art to which this disclosure pertains. In the case of conflict, terms have the meanings provided in the present disclosure.

The singular terms “a,” “an,” and “the” include plural referents unless context clearly indicates otherwise. Similarly, the word “or” is intended to include “and” unless the context clearly indicates otherwise. The term “comprises” means “includes.” The term “about”, when used to refer to a value or range of values, includes the listed value or values, unless the context clearly indicate otherwise. For example, about “X” includes “X.”

As used herein, “ambient dispersion simulator”, or “atmospheric dispersion simulator”, refers to an apparatus, or component thereof, for conditioning a sample from an emissions source to produce a conditioned sample that is similar to an aerosol produced by the interaction of a plume from the emissions source with the atmosphere, such as an apparatus or component that simulates processes such as agglomeration, coagulation, condensation, adsorption, and nucleation that occur when the emissions plume interacts with the atmosphere. In a particular embodiment, the atmospheric dispersion simulator operates by diluting and reducing the temperature of a sample from the emissions source. In a disclosed example, the ambient dispersion simulator is a tank suitably dimensioned and having a suitable flow rate therethrough that provides for adequate dilution and cooling.

As used herein, “continuously monitor” refers to a method of detection capable of making a plurality of discrete, real-time, measurements without intervention by a user. The term continuously monitor does not exclude methods or devices that require occasional user intervention, such as replacement of sample media. Continuous monitoring is in contrast to manual sampling methods where user intervention is required between each distinct measurement, such as removal of sample media for analysis or changing of sample media between each discrete measurement.

General Components of a Continuous Monitoring System

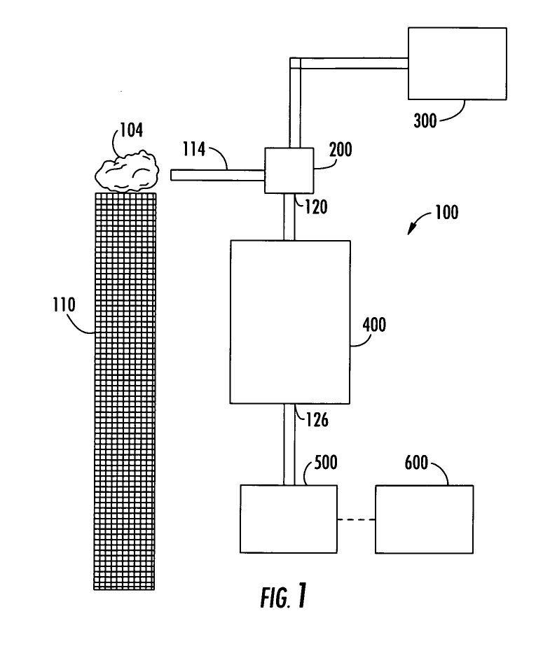

FIG. 1 is a block diagram of a system 100 according to the present disclosure. A sample inlet 114 is placed proximate a gaseous sample 104, such as a sample 104 emitted from a smokestack 110. The gaseous sample 104 is carried through the sample inlet 114 to a mixing chamber 200. The sample inlet 114, in particular implementations, is temperature controlled and can be heated to a desired temperature. The sample inlet 114 may be provided with various sensors (not shown), such as temperature sensors, pressure sensors, flow rate sensors, and moisture sensors. In particular embodiments, the sample inlet 114 includes an isokinetic sampling probe.

A diluting source 300 is in communication with the mixing chamber 200. The diluting source 300 may be a source of clean gas, such as air, or gas, such as CO₂ or N₂, that is substantially free from particulates. For example, ambient air may be passed through one or more filters, such as HEPA and activated carbon filters, to remove particulates and gasses. In a particular implementation, compressed or ambient air is dried by passing it through a recycling, heatless air drier. In certain embodiments, the diluting source 300 or the mixing chamber 200 may be omitted.

The mixing chamber 200 has an outlet 120 in communication with an ambient dispersion simulator (ADS) 400. The ADS 400 has an outlet 126 in communication with a detector 500.

The detector 500 is configured to continuously monitor particles, such as particles of a particle size, or size range, in the gaseous sample 104. In particular embodiments, the detector 500 is configured to continuously monitor multiple particles sizes, or ranges of particle sizes. For example, the detector 500 may be configured to continuously measure PM_{2.5} and PM_{coarse} (which, in certain embodiments, is PM_{10-2.5}). The detector 500 may include multiple detection units, such as beta attenuation monitors, including dichotomous beta attenuation monitors, or tapered element oscillating microbalances. Alternatively, the detector 500 may be a single unit configured to separately detect different sizes of particles.

The detector 500 is in communication with a controller 600 that may be used for data reporting and manipulation, as well as control of various components of the system 100.

In operation, the gaseous sample 104 from the smokestack 110 is carried through the sample inlet 114 to the mixing chamber 200. In the mixing chamber 200, the sample 104 is mixed with a stream from the diluting source 300. After mixing, the diluted sample 104 exits the mixing chamber 200 through the outlet 120 and enters the ADS 400. In the ADS 400, the gaseous sample 104 undergoes one or more chemical or physical changes, such as agglomeration, coagulation, condensation, adsorption, and nucleation. The ADS 400 simulates, at least to a certain degree, the chemical or physical changes the gaseous sample 104 would undergo if released into the atmosphere.

The gaseous sample 104, conditioned by the ADS 400, passes from the outlet 126 into the detector 500. In particular implementations, the detector 500 continuously monitors particles of one or more sizes (or size ranges) in the gaseous sample 104. The detector 500 communicates data related to the gaseous sample 104 to the controller 600.

It should be understood that, in at least some embodiments, the system 100 does not require a diluting source 300. Similarly, the ADS 400 is not limited to an ADS which uses a diluted sample 104. Rather, such embodiments of the system 100 may employ an ADS using any suitable method of simulating the interaction of the sample 104 with the atmosphere. Certain components of the system 100 will now be described in more detail.

The mixing chamber 200 may be any suitable device or method for substantially mixing a stream from the diluting source 300 and the sample stream 104. In one example, the mixing chamber 200 is a tee joint, with an end of the tee in communication with the sample stream 104, an end of the tee in communication with the diluting source 300, and an end of the tee 300 in communication with the ADS 400.

In further embodiments, a diffuser plate (not shown) is placed in the sample stream 104 or the stream from the diluting source 300. The diffuser plate may be, for example, a perforated plate or cone. Suitable diffusion apparatus and methods are described in England, “Development of Fine Particulate Emission Factors and Speciation Profiles for Oil and Gas-fired Combustion Systems, Final Report, 2004.” prepared for: U.S. Department of Energy, National Energy Technology Laboratory, Pittsburgh, Pa.; Gas Research Institute, Des Plaines, Ill.; and American Petroleum Institute, Washington D.C.; (February 2004); and Chang, et al., “Development of Fine Particulate Emission Factors and Speciation Profiles for Oil and Gas-fired Combustion Systems, Update: Critical Review of Source Sampling and Analysis Methodologies for Characterizing Organic Aerosol and Fine Particulate Source Emission Profiles.” prepared for: U.S. Department of Energy, National Energy Technology Laboratory, Pittsburgh, Pa.; Gas Research Institute, Des Plaines, Ill.; and American Petroleum Institute, Washington D.C.; (October 2004); which are hereby expressly incorporated by reference in their entireties (in case of any inconsistency with the present disclosure, the present disclosure shall control). In yet further embodiments, a vortex may be used to help mix the sample stream 104 and the stream from the diluting source 300.

The mixing chamber 200 may of any suitable shape or material. For example, the mixing chamber 200 may be straight or U-shaped. The mixing chamber 200 may be formed from stainless steel, optionally coated with one or more substances, such as Teflon.

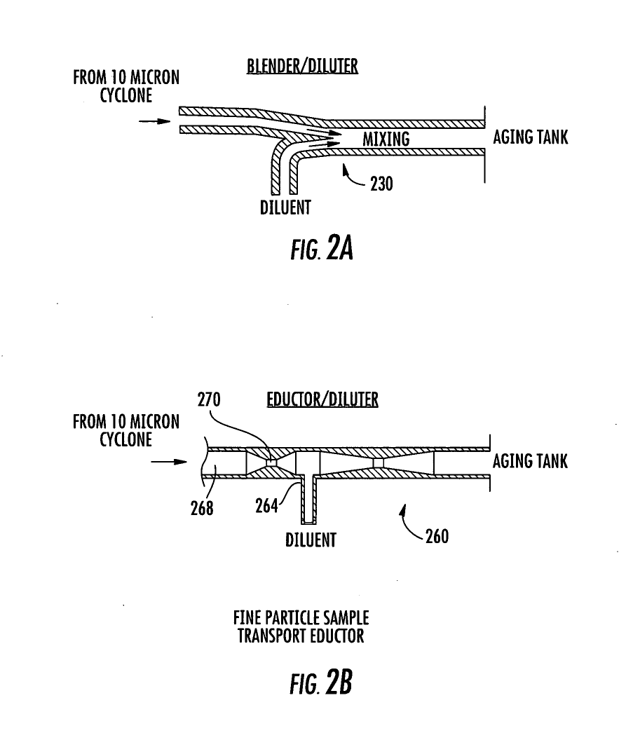

FIG. 2 illustrates examples of mixing systems that may be used in the system 100. With reference to FIG. 2A, a mixing system 230 is a direct dilution, or blending, mixer. With reference to FIG. 2B, a mixing system 260 is an eduction system. The system 230 is configured similarly to the direct Extractive Dilution Approach suggested by England et. al. However, flow measurements are made in areas of the flow stream where particulates are not present, thus minimizing impaction. Minimizing impaction may be beneficial by reducing equipment maintenance issues and also minimizing any loss of particulates which might lead to incorrect results.

In a particular implementation, a totalizing flow meter (not shown) measures the total flow out of the system 100, after all measurements are made. The totalizing flow meter may be, for example, a non-contact flow meter, such as a laser Doppler flow meter or a ultrasonic flow meter. A microprocessor controls an air flow controller (not shown), which measures the amount of diluent entering the mixing chamber 200 from the diluent source 300, such that the difference between the flow measured by the totalizing flow meter and the air flow meter is the sample drawn from the stack. Mass flow controllers and mass flow meters may also be used in this embodiment.

Dilution and mixing can be verified by using a spike gas, such as CO₂, to verify dilution. One CO₂ analyzer (not shown in FIG. 2A) analyzes the raw stack gas being drawn in and the other CO₂ analyzer (not shown in FIG. 2A) measure the diluted sample. The ratio will be the dilution ratio. In particular implementations, the system maintains at least about four percent precision in the dilution ratio.

Referring to FIG. 2B, the eduction system 260 employs an eductor 264. The eductor 264 is driven by clean, dry dilution air from the diluting source 300, which creates a vacuum that draws a sample 268 out of the stack (not shown in FIG. 2B). A choke 270 may be used to restrict the flow from the stack. Because the dilution flow rate is known, and because the choke has known flow versus vacuum characteristics, the eduction system 260 creates a fixed and stable dilution ratio. One suitable eductor is the choke and eductor manufactured by Fox Valve Development Corp. of Dover, N.J. Other eductors include the eductors designed according to Heinsohn, et al., “Dilution source sampling system,” Environ. Sci. Technol., 14, 1205-9 (1980). The eductor 264 may be heated, such as to slightly above the temperature of the stack, to ensure that cooling does not cause any condensation.

The mixing chamber 200 and dilution source 300 are configured to provide a diluted aerosol sample having a desired dilution ratio. For example, in certain embodiments, suitable dilution ratios are of about 10:1 to about 60:1, or higher, such as about 20:1 to about 60:1, or higher. In a particular implementation, the dilution ratio is about 20:1.

In certain embodiments, the mixing chamber 200 is integrated into another component of the system 100, such as the sample inlet 114 or the ADS 400. Integrating the mixer chamber 200 and another component may allow a reduction in the size or weight of the system 100.

In particular embodiments, a combined mixing chamber 200 and ADS 400 has a holding time of about 1 to about 30 seconds, such as about 2.5 to about 30 seconds, such as about 10 to about 30 seconds, such as about 15 to about 20 seconds. In further embodiments, the holding time is at least about 15 seconds, and in a particular implementation is about 15 seconds. Of course, longer equilibration times can be used, if desired. For example, for certain applications, such as for a particular emission source, longer equilibrium times may be used to ensure proper particle formation. For general purpose instruments, longer equilibrium times can be used, such as about 30 to about 60 seconds, such as about 30 to about 45 seconds. However, longer equilibrium times may result in the system 100 becoming larger. Accordingly, particularly in applications where it is desirable to minimize the size of the system 100, the equilibrium time is designed to be relatively close to, or the same as, the minimum mixing time necessary to simulate the particle formation that occurs when an emissions plume from the emissions source 110 (FIG. 1) mixes with the atmosphere.

After the mixer 200, the sample stream 104 enters the ADS 400. The ADS 400 may be dimensioned to provide, in conjunction with other design parameters of the system 100, a suitable dilution ratio and residence time to provide a desired amount of sample aging.

The parameters for sample aging are preferably selected to simulate the interaction of the emissions plume from the emissions source 110 with the atmosphere, for example, by providing similar agglomeration, coagulation, condensation, adsorption, and nucleation of particles in the sample stream 104. Factors that contribute to sample aging include the residence time of the sample 104 in the ADS 400, the dilution ratio of how much the incident sample stream 104 is diluted by the stream from the diluting source 300, the temperature of the stream from the diluting source 300 and the sample stream 104, and the temperature at which aging occurs. The dilution ratio, sample residence time, and temperatures may vary based on the nature of the sample stream 104, such as the nature of the emissions source 110. In a particular embodiment, the ADS 400 is maintained at a substantially ambient temperature.

The dilution ratio can be measured, among other ways, by the formula below:

$$DR = \frac{{Q}_{sample} + {Q}_{dilution}}{{Q}_{sample}} .$$

Where DR is the dilution ratio, Qₛₐₘₚₗₑ is the sample flow rate, and Q_{dilution} is the flow rate of the diluent. Suitable dilution ratios are between at least about 10:1 and at least about 150:1, preferably at least about 20:1 to at least about 80:1, more preferably at least about 20:1 to at least about 50:1. In a particular implementation, the dilution ratio is about 20:1. In another particular implementation, the dilution ratio is about 24:1.

The sample residence time may be from about 1 seconds to about 30 minutes, such as about 2.5 seconds to about 120 seconds, such as about 10 seconds to about 120 seconds, in particular, about 10 seconds to about 80 seconds. A particular implementation employs a residence time of about 10 seconds. The variables for a particular application can be determined empirically, such as by comparing the results from a test set of variables to data obtained by another measurement method, such as a manual measurement method. The variable can then be adjusted to provide the desired correlation with the manual measurement method.

After leaving the ADS 500, the sample stream 104 enters a detector 600. The detector 600 may be any suitable detector for measuring particulates in an aerosol, such as beta attenuation monitors and microbalances, such as tapered element oscillating microbalances (TEOM). In particular embodiments, the detector 600 is a beta attenuation monitor, such as a beta attenuation monitor capable of measuring a plurality of distinct particle sizes, or ranges of particle sizes. For example, the detector 600 may measure the amount of coarse particles in the sample stream 104 and the amount of fine particles in the sample stream 104, such as measuring PM_{2.5} and PM_{coarse}. Suitable beta attenuation monitors are available from Kimoto Electric Co., Ltd., of Osaka, Japan, such as the SPM-613D. The SPM-613D uses a virtual impactor in order to separate coarse and fine particulates, which are then measured in a conventional manner. Other separation devices, such as a cyclone, could be used to separate fine and coarse particles. The SPM-613D is configured to continuously monitor PM_{coarse} and PM_{2.5}. Beta attenuation monitors typically collect sample on multiuse sampling media, such as tape, such as glass fiber or Teflon tape. As used herein, multiuse sampling media refers to sample media that is capable of recording multiple measurements without needing to be changed by an operator. Polycarbonate films, such as Nuclepore® polycarbonate membranes (available from Whatman PLC of Brentford, UK), could also be used for sample collection or for calibration. In a particular example, a polycarbonate film is inserted between two thin plates, such as stainless steel plates. Any electric charge retained by the polycarbonate film can be removed, such as by using a suitable charge neutralizer.

The Teflon tape is typically supplied in rolls. The instrument periodically advances a new piece of tape into the measuring path. The criteria for tape advancement are the passage of a settable period of time, typically one to 4 hours, or the accumulation of enough material that the pressure drop is excessive, resulting in the inability of the flow controller to maintain constant flow. When the tape is advanced, the instrument stops sample flow for a few minutes and accumulates a zero value that is used for subsequent measurements of the particulate mass that accumulates on the tape spot. Establishing a new zero value for each tape section compensates for any variations in mass cross section of the tape. Rolls of tape typically last from 3-6 weeks depending on the amount of particulate material sampled. In a particular implementation, the detector 500 may generate an alarm, such as an email or page to an operator, when the end of a tape roll is imminent.

The detector 500 may be equipped with a manual switch that allows detection media, such as the tape in a beta attenuation monitor, to be changed. The manual switch may allow media to be changed by a relatively unskilled user, who is not fully trained in instrument operation.

Beta attenuation monitors operate on the principal that most matter absorbs beta radiation in a predictable way, as a function of the mass of the material, and the ratio of its atomic number to its atomic weight. Since, for the majority of elements in the periodic table, the ratio of the atomic number to the atomic weight is relatively constant, beta attenuation is very close to a direct mass measurement.

In order to implement a beta attenuation monitor, a source of beta radiation and means of measuring the flux of the radiation are needed. Beta radiation is electrons that are released from radioactive isotopes of some common elements. For safety and measurement accuracy, isotopes that emit only beta particles are typically used for this measurement. The most commonly used isotopes are ¹⁴C, ⁶³Ni, and ¹⁴⁷Pm.

Detection of the radiation is typically by a method called scintillation detection. The Beta radiation strikes a specially formulated material, such as a plastic, that emits a flash of light each time a beta particle strikes it. A detector, such as a photomultiplier tube, detects the light. The number of flashes per unit time is a measure of the flux of beta particles. This scheme is very similar to a light photometer, using beta particles instead of light photons.

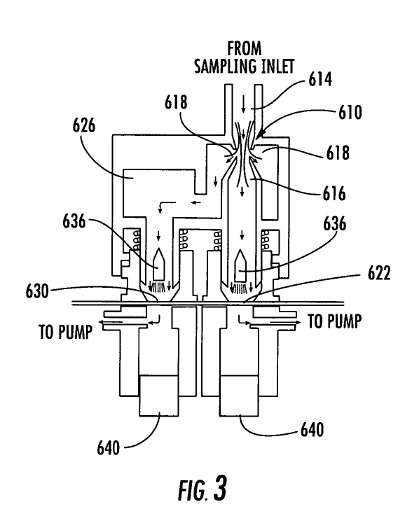

FIG. 3 illustrates the configuration of the dual detection system used in the Kimoto SPM-613D. A virtual impactor 610, a device using an air stream to separate particles according to size based on their inertia, is machined into the sample inlet 614 to separate different sized particles, or particles falling within different size ranges, such as particles larger than 2.5 μm from particles smaller than 2.5 μm. However, other separation devices, such as a cyclone, could be used to separate fine and coarse particles. Coarse particles 616 pass straight through the virtual impactor 610 to a first section of Teflon sample tape 622. Fine particles 618 are directed outside of the virtual impactor 610 where they are channeled to a separate detection section 626 where they pass to a second section of Teflon filter tape 630. Each detection section 622, 630 is positioned between a Beta radiation source 636 and a detection unit 640.

The Beta detection scheme detects the mass of most materials, including the tape itself and water. Accordingly, it is preferred that the sample tape not be hydroscopic. The SPM-613D uses a specially formulated Teflon tape of uniform cross section. Teflon is hydrophobic, helping to ensure that only the water that is actually equilibrated into the particle mass is measured. Polycarbonate film could also be used.

Using the Kimoto SPM-613D, a typical set up is as follows. An incoming sample stream 614, typically at a flow rate of 16.7 liters per minute, encounters the virtual impactor 610 and is divided into two flows. A first flow, typically having a flow rate of 1.3 liters per minute passes straight through the virtual impactor 610 and onto a first segment 622 of detection media. This first flow deposits larger particles onto the first segment of the detection media 622 to be detected by a first detector 640. The second flow, typically having a flow rate of 15.4 liter per minute is directed to a second section of detection media 630 to be detected by a second detector 640.

The virtual impactor and appropriate flow rates separate particles less than 2.5 microns from those greater than 2.5 microns. The nature of the virtual impactor is such that a portion of the fine particles end up collected in the coarse channel due to the flow. The fine channel accumulation can be increased to correct for this. The correction factor is approximately the ratio of the flows. A portion of the mass collected in the coarse channel should be subtracted from the result to account for the fines collected there. The equations for determining PM₁₀, PM_{2.5}, and PM_{course} are provided below. The equations can be modified for different flow rates and similar equations can be developed for other particle size separations.
[PM_{2.5}]=[fine]*(16.7/15.5)
[PM_{coarse}]=[coarse]−fine]*(1.2/15.5)
[PM₁₀]=[fine]+coarse]
Data may be collected or reported in a number of formats, such as continuous one minute data or one hour averages, which may be synchronized to a clock and recorded on the hour.

The instrument can be calibrated by inserting a Mylar film (or polycarbonate film) of known mass cross section into the sample path, over the clean piece of tape that was used to set the instrument zero. The Mylar film simulates mass accumulated on the filter from a sample. The reading on the film is compared with the current calibration factor. If the reading differs more than a desired amount, the operator can cause the system to adjust its calibration factor.

In an alternative embodiment, the sample stream 104 is subjected to a separation step prior to detection of particulates. For example, the sample stream may be passed through one or more cyclones in order to obtain sample streams having particulates of a certain size. Each sample stream can then be passed to an appropriate detector. One potential advantage of this system is that a greater variety of detectors can be used since the detector need only measure one particulate size, or size range, at a time.

The controller 600 may be a custom computer or a standard component, such as a personal computer, or components of a personal computer, running appropriate software to interact with the system 100. A number of functions may be implemented on the controller 600.

One such function is a certification function. The certification function allows the system 100 to be certified, such as by comparison with a manual sampling technique. For example, when the detector 500 is a beta attenuation monitor, a standard filter or film, such as piece of Mylar or polycarbonate film, can be inserted into the detector 500. For example, in response to a command from the controller 600, the detector 500 advances the tape, sets its zero and indicates that it is ready. An operator can then manually activate the detector 500, such as by pressing a button or entering a command, starting a manual test period that may continue until the operator presses a stop button or enters a stop command. In at least certain embodiments, the detector 500 collects data over a particular accumulation period, such as a one minute accumulation period. At the end of the manual sample collection period, the controller 600 reports the average value for the period of the sampling.

Another function that can be provided by the controller 600 is an adjustable rolling average function. The adjustable rolling average function sets the signal integration time (rolling average interval) to give the desired balance between signal variability and response time. This function may be set by the operator.

Another function is outputting particulate data in multiple formats. For example, in a particular embodiment, the controller 600 reports PM_{coarse}, in addition to PM₁₀ and PM_{2.5}. Other values may also be reported, such as PM_{fine}, and total particulates.

Another possible function of the controller 600 is outputting data as a rolling average, rather than accumulation data that is typically used for ambient monitoring. Allowing for reporting of rolling averages allows the operator to set a maximum interval to ensure no excessive zero drift.

The controller may be configured to communicate externally to the system 100, such as to a remote user over a network, such as the internet, a wide area network, a local area network, or a virtual private network. The controller may also be configured to communicate via a number of buss protocols, such as MODBUS, ISABUS, RS422, USB, I2C, and SPI. Data may be output on a continuous basis, at selected intervals, or in response to an externally generated request.

Data may be provided to a number of users, such as to the operators of the emissions sources or regulatory agencies. When provided to operators of the emissions source, the data may be integrated into an existing control system used to monitor and control the emissions source. When data is sent to regulatory authorities, the data may be sent directly to those authorities, and optionally encrypted or otherwise secured, to prevent tampering with such data.

In certain embodiments, the controller 600 is configured to provide for remote control of various components of the system 100. In further embodiments, the controller 600 is programmed to generate alarms, or otherwise communicate with an external user, in response to certain events, such as equipment malfunction or maintenance requests, such as an alarm that detector media needs to be changed soon, when values of sensors are out of range, or when a door or other opening of the system 100 is open or ajar, such as in response to a contact closure sensor. In a particular example, the system 100 is provide with the temperature and pressure sensors specified in Method 039 and the controller 600 is in communication with such sensors. Data can be flagged when particular types of events occur, such as events that generate an alarm.

The controller 600 may be configured to control various components of the system 100, and to monitor various parameters and analyzers, such as sensors to measure temperature, pressure, moisture, and flow rate within the system 100. In addition to monitoring such parameters, the controller 500 may be programmed to automatically adjust operating parameters of the system 100, such as temperatures and flow rates, in order to maintain proper operation of the system 100. The controller 600 may also be used to archive system data and information regarding maintenance activity. In further examples, the controller 600 is configured to perform various diagnostic tests, including self-diagnostics and diagnostics on various components of the system 100.

Particular Implementation of a System for Continuous Emissions Monitoring

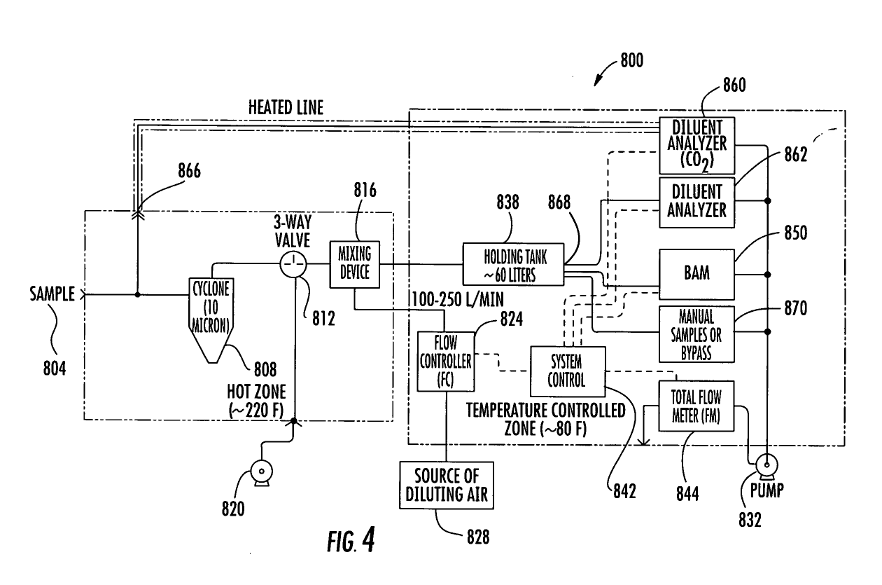

FIG. 4 illustrates a particular implementation of a system 100, referred to generally as 800. A sample 804 is drawn from an emissions source (not shown) through a 10 μm cyclone 808 in order to filter out larger particles from the sample 804. Filtering out such large particles can reduce maintenance and wear on the system 800.

The sample stream 804 passes through a three-way valve 812, such as a bore through valve. The three way valve 812 is selectively in communication with a mixing device 816 and flow from a pump 820. The pump 820 may be used to initiate a blowback cycle to push contaminants that may build up in the cyclone 808 back in the emissions source (such as the stack). In a particular implementation, the blowback cycle consists of a 100 psi air stream applied for 10 seconds. Of course other pressures and durations can be used, as appropriate. The blowback cycle may be selected to occur periodically, such as daily, upon command, or as determined by a sensor.

The mixing device 816 is in communication with a flow controller 824, which is in turn in communication with a source of diluting air 828. In this particular implementation, the diluent air 828 is from a compressed air source, such as a compressed air source having a pressure of about 30 to about 50 psi, that has been filtered to remove particulates and other gases, as appropriate. For example, the diluent air may be filtered through one or more of a HEPA filter, an activated carbon filter, and filters to remove certain gases.

The flow controller 824 allows for an external signal to set the flow rate of diluent air 828 into the system 800. A flow meter (not shown) measures the flow out of the mixing device 816. An integrating tank (not shown) is mounted in front of the flow meter to smooth out any pulsation from the pumps, such as pump 832, that are drawing from an aging tank (atmospheric dispersion unit) 838.

In operation, a system controller 842 is in communication with the flow controller 824 and sends a signal to set the flow controller 824 to the total flow, as measured by the total flow meter 844, less the flow required from the stack to make up the desired dilution ratio. That is:
FC=FM*(1−DR)
where FC is the flow rate at the flow controller 824, FM is the flow rate at the flow meter 844, and DR is the dilution ratio. In certain embodiments, the flow at the flow controller 824 is from about 100 to about 250 liters per minute. If desired, a sample flow meter (not shown), such as a pressure differential flow meter, or a non-contact flow measuring device, such as a laser Doppler or ultrasonic meter, may be included in the sample line, such as on either side of the valve 812.

If desired, the flow rate of the system 800 can be calibrated, such as by closing the valve 812. When the valve 812 is closed, the total system flow should be equal to the flow of the diluent 828. Other calibration schemes may also be used, such as zero flow calibration and multipoint calibration.

The diluted sample 804 passes from the mixing device 816 to the aging tank 838. The dimensions of the tank 838 are typically selected based on the volume of gas (diluent and sample) the system 800 will process. For example, the system 800 may be designed to operate using a total flow rate through the system 800 of between about 100 liters per minute and about 200 liters per minute. This flow rate may provide about a 15 second minimum aging time and a 30 second nominal aging time. These parameters result in an aging tank 838 having a capacity of about 50 liters. Although the tank 838 may be any suitable shape, ease of construction, cost, and packaging considerations suggest, at least in certain implementations, a cylindrical tank 838. In other embodiments, the tank 838 is square or octagonal. With unmixed samples, the dimensions of the aging tank are typically selected to provide a length to diameter ratio of 8:1. For systems with a premixed sample, such as the system 800, a lower length to diameter ratio may be used, such as a ratio of about 6:1. The ratio may be selected to help ensure that no stratification occurs. Suitable length to diameter ratios may include those from about 4:1 to about 12:1. Applied to the system 800, these criteria result in a tank 838 that is approximately 9 inches in diameter and 50 inches in length.

In other implementations, the aging tank 838, and other components of the system 800, are configured, according to the above identified parameters, for total flow rates of 100 liters per minute or less. The minimum flow rate, in at least some embodiments, is determined by the flow required by the beta attenuation monitor 850, and any other detectors in the system 800. For example, certain implementations of the system 800 are configured to operate at flow rates of at least about 33.4 liters per minute, such as at least about 38.4 liters per minute.

The components of the system 800, particularly those components that transport the sample 804, may be heated to approximately stack temperature to help prevent condensation of volatile components or water. The aging tank 838 may be heated, if desired, such as to help prevent condensation.

A portion of the sample 804 exiting the aging tank 838 is drawn into a beta attenuation monitor 850 configured to detect one or more sizes of particles, or ranges of particle sizes, in the sample. For example, PM_{fine}, PM_{coarse}, PM_{2.5} and PM₁₀ may be measured using the Kimoto SPM-613D as the beta attenuation monitor 850.

Dilution analyzers 860, 862, configured to measure CO₂, are included in the system 800. It can be useful to base dilution on CO₂ concentration, since many emissions processes involve combustion. The analyzer 860 measures the CO₂ concentration of the undiluted sample at a point 866. The analyzer 862 measures the CO₂ concentration at a point 868, after the sample has been diluted. The ratio of CO₂ concentrations should be equal to the dilution ratio. For example, assuming a typical CO₂ concentration of 10% measured at the analyzer 860, a 20:1 dilution ratio will yield a CO₂ concentration of 0.5% at the second diluent analyzer 862. Ambient CO₂, typically between 300 and 500 ppm, generally represents about 10% of the diluted value. At a 50:1 dilution ratio, the CO₂ concentration at the analyzer 862 will be 0.2%, meaning that the ambient concentration is as much as 20%.

If it is desired to determine diluent CO₂ concentration, the analyzer 862 can be set to periodically measure the CO₂ concentration of the diluent 828, such as by activating a solenoid valve (not shown) to send the diluent 828 to the analyzer 862. The CO₂ concentration of the diluent 828 may be stored in the controller 842.

In a further embodiment, the system 800 can be equipped with a valve (not shown) to prevent air from reaching the detector 850. Such a valve may be used to prevent flow in the system 800 from reaching the detector 850 when detector media is being changed or advanced in the detector 850, or when the system 800 is to be calibrated. Although a flow shutoff valve can be used, a bypass valve may be particularly useful, such as to avoid disruptions in the dilution ratio.

A manual sampling, or bypass, port 870 can be provided to allow samples to be manually removed from the system 800. Such samples can used to calibrate or verify proper operation and accuracy of the system 800.

Implementation of an Apparatus for Continuous Emissions Monitoring

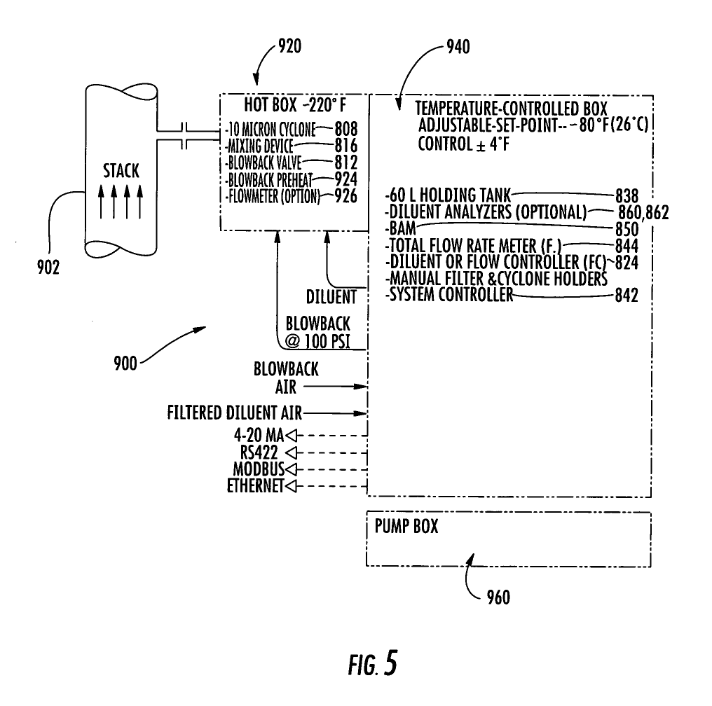

FIG. 5 is a schematic diagram showing how the system 800 of FIG. 4 may be packaged into an apparatus 900 configured to be mounted proximate an emissions source 902. The apparatus 900 includes three sections, a hot box 920, a temperature controlled box 940, and a pump box 960.

The hot box 920 is heated, such as to 200° F. or to 220° F., to help prevent water in the sample 804 from condensing. The hot box 920 includes the cyclone 808, the valve 812, and the mixing device 816. The hot box 920 optionally includes a preheater 924 for the blowback gas and a flowmeter 926.

After passing through the hot box 920, and being diluted by the diluent 828, the sample 804 passes into the temperature controlled box 940. The temperature controlled box 940 is typically set to an ambient temperature, as appropriate in view of prevailing moisture and temperature conditions. In particular implementations, the temperature controlled box 940 is set to ambient temperature. In other implementations, the temperature controlled box 940 is heated to a temperature above the ambient temperature or cooled to a temperature below ambient temperature. Temperature may be controlled by any suitable means, such as a heat pump (not shown).

The temperature controlled box 940 contains the aging tank 838, in this implementation, a 60 liter aging tank 838, the diluent analyzers 860, 862, the beta attenuation monitor 850, the total flow meter 844, the flow controller 824, and the controller 842. If desired, the temperature controlled box 940 may be subdivided in a number of compartments.

In a particular example, a first compartment contains the holding tank 838. A second compartment contains instrumentation, such as the diluent analyzers 860, 862 and the beta attenuation monitor 850. A third compartment provides access for manual sampling methods, such as manual sampling port 870. Subdividing the temperature controlled box 940 into multiple compartments may help avoid unnecessary exposure of components of the system 800 to damage, contamination and so forth, but allows access to certain components for which access is desirable. For example, it may be desirable to have easy access to the beta attenuation monitor 850, such as to allow media, such as tape, to be easily accessed and changed. Similarly, it may be desirable to have easy access to the manual sampling port 870.

The pump box 960 holds one or more pumps, such as sample pumps, blowback pumps, and pumps associated with various instruments of the apparatus 900. In particular, pumps 820 and 832 are disposed in the pump box 960. The pump box 960 is typically ventilated. In a particular example, the pump box is provided with a fan, such as a smart fan that is activated at high ambient temperatures. Separating pumps from the rest of the apparatus 900 may reduce heating and cooling costs, and may also isolate the remainder of the apparatus 900 from noise or vibration associated with the pumps.

The enclosure of the apparatus 900, including the hot box 920, the temperature controlled box 940, and the pump box 960, are, in certain embodiments, ruggedized to withstand various temperature and weather fluctuations associated with exposure to the elements at an operating site proximate the emission source 902. For example, the apparatus 900 may be designed to comply with various NEMA standards. In a particular embodiment, the apparatus 900 includes one or more housings that comply with the NEMA 4 standard. In more particular implementations, the apparatus 900 is configured to maintain 85° F. at ambient temperatures of up to 120° F. and maintain 68° F. at temperatures to −20° F.

In a further embodiment, the controller 842, and optionally a data display, are located remotely from the apparatus 900. When the controller 842 is located remotely from the apparatus 900, the controller 842 may be placed in communication with the apparatus 900 through a suitable wireless or wired connection, such as an Ethernet connection.

In further embodiments, the bulk of the apparatus 900, including the hot box 920, the temperature controlled box 940, and the pump box 960 are located remotely from the emissions source 902. In such cases, a sample line, such as a heated pipe, may be used to transport a sample from the emissions source 902 to the bulk of the apparatus 900. Such a design may provider greater user flexibility and convenience. In addition to heating the sample transfer lines, additional steps can be taken to reduce particle losses in the sample line, such as coating the interior of the transfer lines with a coating, such as Teflon, to reduce deposition. Similarly, the sample line may be treated to help reduce electrostatic problems, such as charged particles sticking to the sides of the sample transfer line.

Further Applications

In addition to the benefits noted above, the methods, systems, and apparatus of the present disclosure may provide other benefits. For example, emissions trading, whereby entities can trade rights to emit various substances into the environment, is a developing regulatory and economic model. While used for substances such as greenhouse gases, there is presently not a market for trading particulate emissions. One reason for the lack of such a market is the unavailability of a suitable method to quantify particulate emissions. The present disclosure provides for the emergence of a market for particulate emissions trading by providing for real-time, accurate, and convenient measurement of particulates.

The utility of the subjects of the present disclosure can be further increased by coupling them with other techniques. For example, additional detectors, such as detectors for elemental or chemical analysis, or detectors of particle size distribution, can be included in the disclosed subject matter. The inclusion of such additional detectors may provide for a single, compact unit suitable for mounting proximate an emissions source, such as a static emissions source, that performs a variety of measurements on emissions.

### EXAMPLE

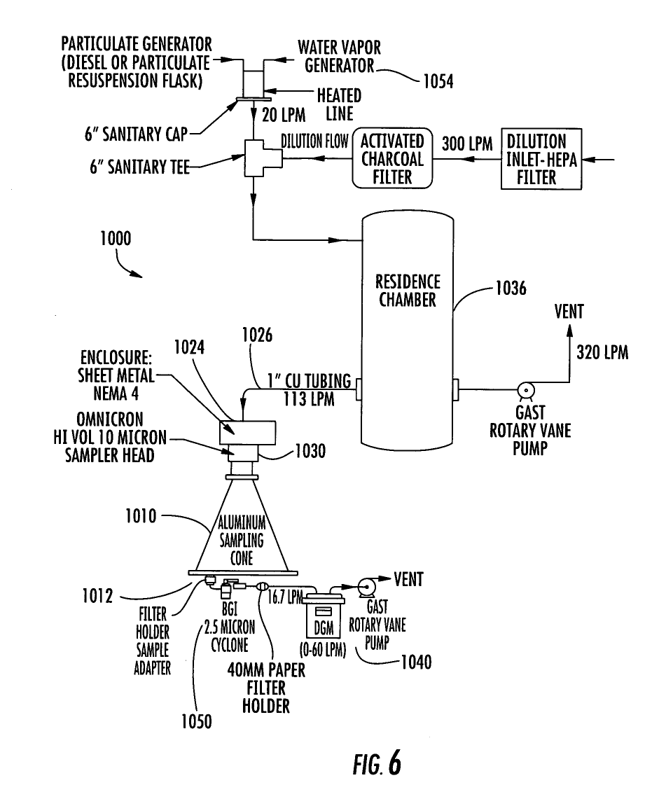

With reference to FIG. 6, a test system 1000 was prepared in order to confirm that the disclosed systems are useable to continuously measure particulates. The measuring ranges that might result from the beta attenuation monitor (not shown in FIG. 6) connected to the system 1000 were determined.

The beta attenuation monitor used in the test system 1000, the SPM-613D, is specified to have a minimum detectable concentration of 2 μg/m³ based on a one hour average. A 15 minute response time was chosen as being reasonable for use in real world monitoring applications. Thus, the lower detection limit of the system 1000 was 10 μg/m³ on the basis that the random variations in zero will double for one-quarter the integration time, based on using 4a as the lower detection limit. If a one hour average measurement is used, a lower minimum measurable concentration of 100 μg/m³ may be assumed. At a dilution ratio of 20:1, the minimum measurable stack value is 200 μg/m³.

Going to the other end of the scale, the beta attenuation monitor is specified to measure to 1 mg/m³. Thus at a maximum dilution ratio of 100:1, this stack concentration as high as 100 mg/m³ can be measured. In fact, the BAM was able to measure to well above 5 mg/m³. Dilution ratios above 100:1 should be achievable, with a few changes to the system design, with possible compromise of low concentration performance.

In Provisional Test Method 040, the operator is advised to expect concentrations around 0.0015 gr/dscf, with 40% being PM₁₀ and 20% being PM_{2.5}. This equates to approximately 14 mg/m³ for PM₁₀ and 7 mg/m³ for PM_{2.5}. Typical turbine value expected values are in the range of 1 mg/m³, most of which is PM_{2.5}. Typical incinerators produce particulates in the range of 2-5 mg/m³. Therefore, a target measuring range of 0.2 to 100 mg/m³, using 20:1 to 40:1 dilution, was assumed to be a suitable measuring range for practical applications of the system 1000.

In order to allow comparison of results from manual gravimetric samples with results from a beta attenuation monitor using simultaneously taken measurements, the test system 1000 was equipped with a sampling cone 1010 with multiple ports 1012 for manual filter holders (not shown) as well as ports to attach instruments (not shown), including the beta attenuation monitor. Samples drawn off the cone 1010 are substantially uniform, ensuring insignificant sampling position based bias.

In order to limit PM_{coarse} to particles less than 10 μm, a 16.7 l/min cyclone 1024, available from BGI, Inc., of Waltham, Mass., was installed in the inlet line 1026 prior to the sampling cone 1010. The system 1000 was configured to provide at least 50 liters per minute of sample, allowing multiple samples to be drawn from the system 1000. In order to help ensure that no particles larger than 10 microns were measured, a Blue Top 10 micron sampling head 1030 intended for use on a Hi-Volume Sampler was adapted for use in the system 1000. A steel plenum was created to fit over the top of this head which was connected to the dilution chamber 1036 via a 1″ copper pipe. The sampling cone 1010 was attached to the bottom of the 10 micron inlet. The Blue Top is rated to make the 10 micron cut at 113 liters per minute, which was maintained in all tests, using a pump to make up the difference between the flows of all the devices connected to the system 1000 and the desired 113 l/min flow rate.

The system 1000 was tested for leaks that might bias results. With the sample inlets plugged, the system 1000 was capable of holding a 10″ water column vacuum for minutes.

The beta attenuation monitor was connected to the center port (not shown) of the sample cone 1010. The manual samples were connected to other ports as were the other analyzers. Two model 1-100 particle size distribution analyzers, available from GRIMM Aerosol Technik GmbH & Co. KG, of Ainring, Germany (not shown) were used to measure the particle size distributions. One particle size distribution analyzer was connected to the aging tank 1036 and the other particle size distribution analyzer was connected to the sampling cone 1010. A Dust Track PM₁₀ dust analyzer, available from TSI, Inc., of Shoreview, Minn. (not shown) was connected to the cone 1010. These analyzers were mainly used to aid in setting dust levels for tests and to verify particle size distributions.

The manual sample systems consisted of filter holders connected to carbon vane pumps, available from Gast Manufacturing, Inc., of Benton Harbor, Mich., with dry gas meters 1040, such as digital dry gas meters, available from Equimeter, in the line to measure accumulated air sampled. FIG. 6 illustrates a system used to measure PM₁₀. A system for measuring PM_{2.5} is identical to that shown in FIG. 6, except for the removal of a 2.5 micron cyclone 1050. Dry gas meters 1040 had current calibrations against primary standard Bell Provers.

A 16.7 l/min 2.5 micron cyclone 1050 was put in front of one of the filters to allow a PM_{2.5} manual sample to be taken for comparison to the BAM measurements. The filters were 47 mm diameter Teflon and were pre-weighed before installation into the filter holders. Sampling times were typically one hour during which about 1 cubic meter of sample was collected. The weighing lab used to quantify manual samples tracks its uncertainty day to day, allowing uncertainty in the final result to be reduced. Weighing and sampling error contributed less than 5 μg/m³ to the overall measurement uncertainty in all reported results.

A pump was used to maintain the total flow rate through the dilution system and the aging tank at about 450 liters per minute. With 10 to 15 liters per minute of sample, dilution is maintained above 20:1 and is calculated from the flow rates.

A water generator 1054, available from Baldwin Environmental, Inc., of Reno, Nev., was employed to simulate stack water vapor. The water generator 1054 uses a displacement piston pump to inject a known volume of liquid water into a boiler where the resulting steam is mixed with clean, dry air. The pump and air flow rates are adjustable. Air flow rates are controlled by Tylan mass flow controllers (not shown) that have been calibrated against secondary standard dry gas meters. The water generation system employed is capable of generating up to 20% by volume water vapor concentration at 10 liters per minute. In certain measurements, moist air was mixed with the particulate sample and introduced into the system 1000. During “dry” runs, the water was simply shut off, resulting in dry diluent gas.

The particulate samples used to test the system 1000 were suspended in 1 l/min of dry air so the actual water concentration was about 19%, still well above typical stack conditions of 5-12%. Higher concentrations of water were used since, after wet scrubbers or when burning medical waste, higher water levels might be encountered. After 25:1 dilution, the moisture content was slightly under 2%, resulting in a relative humidity in the aging chamber of a measured nominal 35% for “wet” tests.

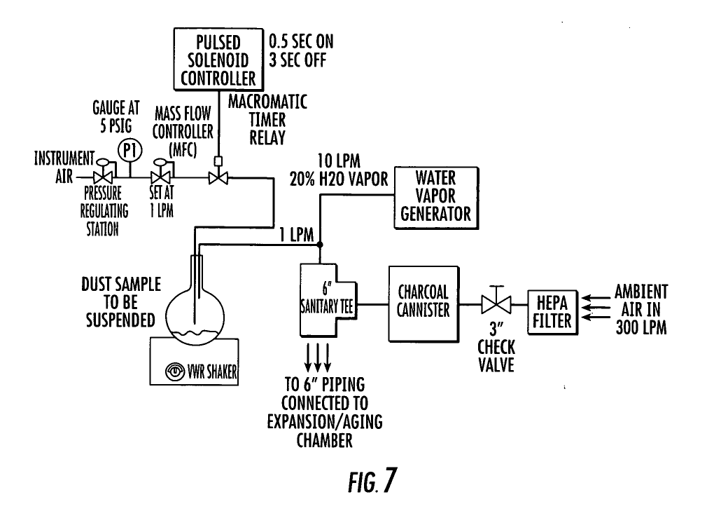

Simulated samples were generated in one of two ways. In the first method, a small dust re-suspension device was used, shown in FIG. 7. Pressurized air was pulsed onto a small amount of dust which was then suspended in a flask and swept into a simulated stack stream and then to the system 1000. A duration timer (not shown) allowed the duration, pressure, and interval of the pulses to be controlled. Control of these factors allowed the dust concentration to be controlled. A small volume of air was swept through flask at a constant flow rate, controlled by a mass flow controller.

According to a second method of simulated sample generation, fine salt particles were generated using a TSI Nebulizer to create a mist of saline solution. The mist was sent through a heated line to drive off the water, leaving behind particles which were introduced into the system 1000.

Typically testing procedure occurred as follows. At the beginning of a test series, all of the pumps were set to the proper flows by adjusting valves attached to the pumps. The pumps for manual samples were then turned off. The sample to be tested was generated according to one of the methods described above. The instruments were observed. When the instruments were stabilized, filter holders with pre-weighed filters were connected to the pumps. The starting reading on the dry gas meter was recorded for each filter.

At the start of the test, the general conditions were recorded, the filters were inserted into the cone, and the pumps started along with a stop watch. The time on the beta attenuation monitor was noted. The test was run for the prescribed time, typically 1 hour. At the end of a test, the manual pumps were stopped, the filters removed and the ending readings from the dry gas meters were taken. The filter packs were subjected to gravimetric analysis. The one minute data from the BAM were collected via the Ethernet port, and the final condition data were recorded.

Results

Zero Stability: The unit was quite stable. In one long term test, one month, an air stream passed through a HEPA filter was used as the sample. The system 1000 averaged 0 μg/m³ with a standard deviation of ±2 μg/m³, using individual 20 minute average readings. Using ten minute average readings from the system 1000 resulted in an average of 1.4 times the standard deviation for the individual ten minute readings, or just under ±3 μg/m³. For calculation purposes, it was assumed the minimum measurable concentration was about 10 μg/m³. This conservative assumption helps ensure that, even with natural degradation in system performance through normal operation, there will be a long measurement interval.

Correlating the test results to real world applications, if the minimum measurable concentration is based on a 15 minute average and a 20:1 dilution ratio, the 10 μg/m³ minimum measurable concentration of the system 1000 equates to a stack concentration of 200 μg/m³. If the minimum measurable concentration is based on a 1 hour average, the 5 μg/m³ minimum measurable concentration of the system 1000 equates to a stack concentration of 100 μg/m³.

Upscale Reading Stability: This value was determined by manually inserting a film having a known density in the sample path. A suitable Mylar film was provided by Kimoto Electric Co., Ltd., having an equivalent value of 700 μg/m³. The film was manually inserted daily, except on weekends, over one week after all tests were completed to assess short term variance in the span value. Results showed a standard deviation of less than ±2% variation in this short term test. Over a period of 47 days, the value was stable within 2% of the original set point.

Calibration.: Kimoto Electric Co., Ltd., recommends that the operator check the span of the SPM-613D each month, and if it is within 3% of the nominal value, it need not be readjusted. The zero and span stability tests indicated that Kimoto's recommendation is sufficient to maintain measurement within specification. However an absolute error of approximately 40% was observed in the calibration standard provided by Kimoto for this instrument, the SPM-613D reading higher than the gravimetric value. Given the stability of the SPM-613D, the calibration error appears to be a scale factor issue that can be easily resolved.

During the tests, ambient temperature varied over a range of ±4° F. For reasons of preventing condensation and having stable sample equilibration conditions, the housing for the measuring system was controlled to this level.

Beta Attenuation Monitor—Dilution System Operation: One goal of the testing was to validate that, on diluted simulated stack dust conditions, passed through the system 1000, the results from the beta attenuation monitor could be directly and repeatedly correlated with samples taken and measured according to accepted gravimetric methods. In order make this determination under a range of conditions, measurements were made in both wet and dry conditions.

For all wet tests, the simulated stack sample was tested both dry, (equilibrated with room air of about 20% relative humidity) and wet (mixed with air containing 20% by volume water in air) prior to dilution. Dilution ratios were nominally 25:1. The relative humidity and temperature in the equilibration chamber were monitored. In all tests, the temperature was nominally 25° C. and the chamber humidity, after dilution, ranged from a low of 25% to a high of 40%. For all gravimetric comparison tests, a sampling interval of 1 hour was used to collect at least 1 cubic meter of sample. In all measurements where the fraction concentration was above 60 μg/m³, the weighing uncertainty was less than 10%.

The first series of tests involved challenging the system 1000 with re-suspended Delco Arizona Road Dust and a sample of fly ash recovered from a typical utility boiler. In spite of the difference in origin, there was no discemable difference in correlation results between the Arizona Road Dust and the fly ash. That is, there was not a statistically significant difference between the samples in the results of the beta attenuation monitor as compared to the results from the gravimetric method.

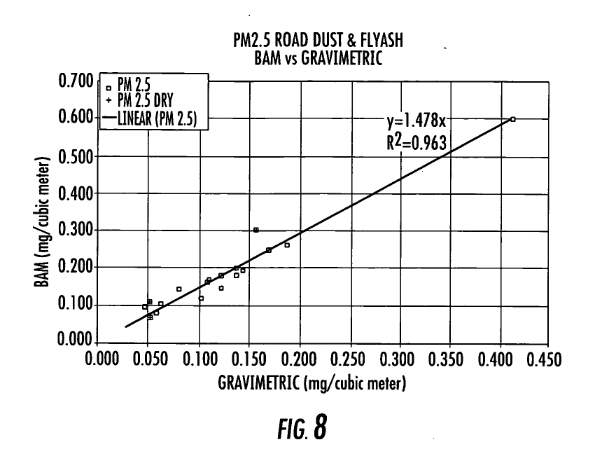

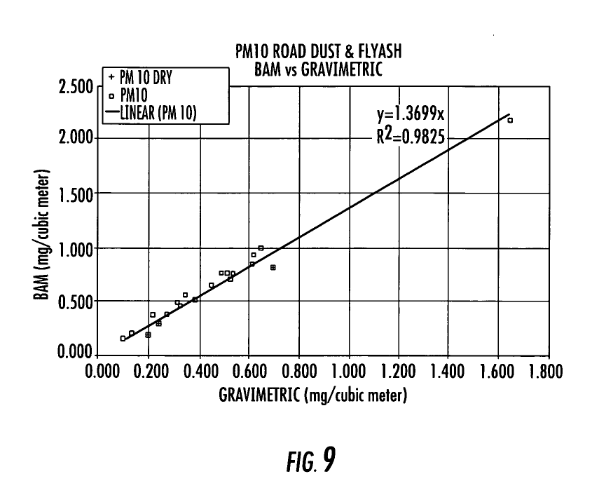

FIG. 8 is a chart of the results for PM2.5 and FIG. 9 is a chart of the results for PM₁₀. In both the PM₁₀ and PM_{2.5} results, the fit of the data to a regression line is excellent. There is no statistical significance between data taken on dry dust versus that where the dust is wet, having been mixed with 20% water vapor before dilution. If the beta attenuation monitor were properly calibrated and doing its math correctly, the slope should be 1 for both PM_{2.5} and PM₁₀. The slopes differ by about 8%. The overall value result as read by the beta attenuation monitor is some 40% above the gravimetric data. As mentioned above, the 40% difference is likely to a scaling problem and is likely to be correctable with a simple software correction. This was verified by applying a correction to the obtained values, which brought the correlation in line with expectations. In the PM₁₀ reading, the instrument was able to read values above 1 mg/m³ with an excellent linear fit.

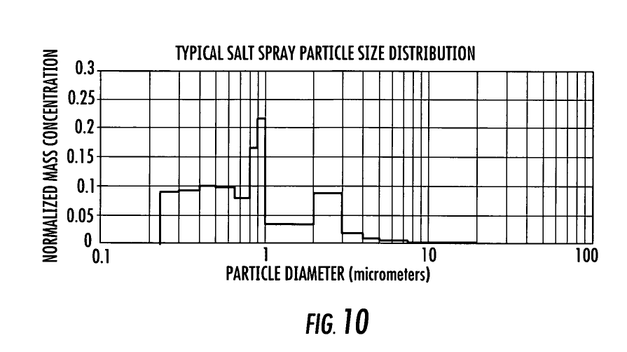

The calibration error was also investigated by looking at the data from fine particles. Fine particles were generated using NaCl solution in the atomizer as the source of particles. There were very few particles larger than 2.5 microns, as verified by the Grimm Particle Size Spectrometer, FIG. 10. Dividing all of the results for both PM₁₀ and PM_{2.5} by 1.42 would have put the results within 5% of a 1:1 slope. The difference in slope between PM₁₀ and PM_{2.5} indicates the possibility of a systematic error in the correction for the virtual impactor.

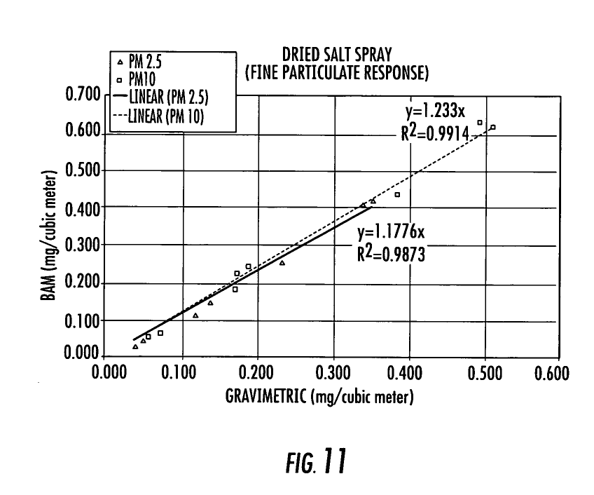

FIG. 11 compares results from the beta attenuation monitor, using the system 1000, to results using gravimetric methods using salt samples. The slope difference from ideal is much smaller than it was with the mixed coarse and fine samples discussed above from the Arizona road dust and fly ash. The smaller slope difference in the fine samples compared to the mixed samples tends to indicate an error in the correction for the virtual impactor.

One way to account for this apparent error is to divide data by the average slope of the results, giving direct mass data. An equivalent result would be obtained by recalibrating the beta attenuation monitor with the same film, but using a value of about 1 mg/m³ instead of 0.7 mg/m³, except for the issue of the impactor correction.

Another option to correct this apparent error is to remove the virtual impactor and install a PM_{2.5} cyclone in its place. All corrections can be removed from the software and direct PM_{2.5} and PM₁₀ values will be obtained, from which PM_{coarse} can be calculated.

It is to be understood that the above discussion provides a detailed description of various embodiments. The above descriptions will enable those skilled in the art to make many departures from the particular examples described above to provide apparatus constructed in accordance with the present invention. The embodiments are illustrative, and not intended to limit the scope of the present invention. Changes may be made in the construction and operation of the various components, elements and assemblies described herein and changes may be made in the steps or sequence of steps of the methods described herein. The scope of the present invention is rather to be determined by the scope of the claims as issued and equivalents thereto.

We claim:

1. A monitoring apparatus of the type useable to continuously monitor particulate emissions, the monitoring apparatus comprising:
(A) a sample inlet operable to conduct an aerosol sample from an emissions source;
(B) a diluent inlet in communication with a source of diluent;
(C) a flow controller connected to the diluent inlet, the flow controller configured to regulate the flow of diluent through the diluent inlet;
(D) a mixing chamber in communication with the sample inlet and the diluent inlet; whereby the aerosol sample and the diluent are mixed within the mixing chamber, thus diluting the aerosol sample to produce a diluted aerosol sample;
(E) an ambient dispersion simulator in communication with the mixing chamber, whereby the ambient dispersion simulator is operable to simulate the interaction of the aerosol sample with the atmosphere and produce a conditioned aerosol sample;
(F) a continuous particle detector in communication with the ambient dispersion simulator, the continuous particle detector comprising multiuse particulate sampling media; and
(G) a pump in communication with the continuous particle detector and the ambient dispersion simulator, the pump operable to pump the conditioned aerosol sample from the ambient dispersion simulator through the continuous particle detector;
whereby at least a portion of particulates in the conditioned aerosol sample interact with the multiuse particulate sampling media and are detected by the continuous particle detector.

2. The monitoring apparatus of claim 1, further comprising a controller in communication with the continuous particle detector, the flow controller, and the pump, whereby the controller is operable to obtain data from the continuous particle detector and to adjust operational parameters of the flow controller and the pump.

3. The monitoring apparatus of claim 1, wherein the ambient dispersion simulator comprises an aging tank dimensioned to provide a residence time for the diluted aerosol sample of at least ten seconds.

4. The monitoring apparatus of claim 1, wherein the continuous particle detector comprises a beta attenuation monitor.

5. The monitoring apparatus of claim 4, wherein the beta attenuation monitor is configured to separately detect coarse particles and fine particles.

6. The monitoring apparatus of claim 4, wherein the beta attenuation monitor comprises a virtual impactor, whereby the virtual impactor is operable to separate fine particles from coarse particles in the conditioned aerosol sample.

7. The monitoring apparatus of claim 1, wherein the continuous particle detector comprises a tapered element oscillating microbalance.

8. The monitoring apparatus of claim 1, wherein the continuous particle detector comprises first and second detecting sections, the first and second detecting sections comprising multiuse particulate sampling media, whereby a first portion of the conditioned aerosol sample is directed to the first detecting section, which detects particles of a first size or range, and a second portion of the conditioned aerosol sample is directed to the second detecting section, which detects particles of a second size or range, the second size or range being smaller than the first size or range.

9. The monitoring apparatus of claim 8, further comprising a particle separator intermediate the conditioned aerosol sample and the first and second detecting sections, the particle separator diverting the conditioned aerosol sample into the first and second sections.

10. The monitoring apparatus of claim 1, wherein the multiuse particulate sampling media comprises a roll of tape.

11. The monitoring apparatus of claim 1, further comprises a particle separator intermediate the mixing chamber and the diluent inlet, the particle separator configured to remove particles larger than a certain size or range from the aerosol sample.

12. The monitoring apparatus of claim 1, further comprising a blowback inlet and a valve in communication with the mixing chamber, the particle separator, and the blowback inlet, the valve configured to selectively regulate flow between the mixing chamber and either the particle separator or the mixing chamber.

13. The monitoring apparatus of claim 1, wherein the continuous particle detector is a first continuous particle detector, further comprising a second continuous particle detector comprising multiuse particulate sampling media, and a particle separator intermediate the ambient dispersion simulator and the first and second continuous particle detectors, whereby the conditioned aerosol sample passes from the ambient dispersion simulator through the particle separator and is separated into first and second sample streams, the first sample stream passing through the first continuous particle detector and the second sample stream passing through the second continuous particle detector.

14. The monitoring apparatus of claim 1, further comprising a housing, the sample inlet penetrating the housing and wherein the mixing chamber, flow controller, ambient dispersion simulator, continuous particle detector, and pump disposed in the housing.

15. The monitoring apparatus of claim 14, wherein the housing is substantially weatherproof.

16. A method of continuously measuring particulates from an emissions source, the method comprising;
obtaining an aerosol sample from an emissions source;
diluting the aerosol sample with diluent to produce a diluted aerosol sample;
passing the diluted aerosol sample through an ambient dispersion simulator to produce a conditioned aerosol sample, whereby the diluted aerosol sample undergoes chemical or physical changes similar to chemical or physical changes that would occur if the aerosol sample interacted with the atmosphere;
passing the conditioned aerosol sample from the ambient dispersion simulator into a detector; and
continuously monitoring the quantity of particles of a certain size or range in the conditioned aerosol sample.

17. The method of claim 16, wherein continuously monitoring the quantity of particles of a certain size or range in the conditioned aerosol sample comprises automatically making a plurality of measurements of the quantity of particles of a certain size or range in the conditioned aerosol sample.

18. The method of claim 16, further comprising, prior to continuously monitoring the quantity of particles of a certain size in the conditioned aerosol sample, allowing particles in the conditioned aerosol sample to accumulate on sample media in the detector and wherein continuously monitoring the quantity of particles of a certain size or range in the conditioned aerosol sample comprises continuously monitoring the quantity of particles of a certain size or range in the conditioned aerosol sample without removing the sample media from the detector.

19. The method of claim 16, wherein the emissions source is a static emissions source.

20. The method of claim 16, further comprising, prior to diluting the aerosol sample with diluent to produce a diluted aerosol sample, separating particles larger than a predetermined size from the aerosol sample.

21. The method of claim 16, wherein passing the diluted aerosol sample through an ambient dispersion simulator to produce a conditioned aerosol sample comprises retaining the diluted aerosol sample in the ambient dispersion simulator for at least about ten seconds.

22. The method of claim 16, wherein diluting the aerosol sample with diluent to produce a diluted aerosol sample comprises diluting the aerosol sample with diluent in a ratio of at least about 20:1.

23. The method of claim 16, further comprising:
prior to passing the conditioned aerosol sample from the ambient dispersion simulator into a detector, separating the conditioned aerosol sample into a first stream substantially comprising particles of a first size range and a second stream substantially comprising particles of a second size range, the second size range comprising larger particles than the first size range;
wherein passing the conditioned aerosol sample from the ambient dispersion simulator into a detector comprises passing the first stream into a first detector and passing the second stream into a second detector; and
wherein continuously monitoring the quantity of particles of a certain size in the conditioned aerosol sample comprises continuously monitoring the quantity of particles in the first size range with the first detector and continuously monitoring the quantity of particles in the second size range with the second detector.

24. The method of claim 16, further comprising:
prior to continuously monitoring the particles of a certain size or range in the conditioned aerosol sample and subsequent to passing the conditioned aerosol sample from the ambient dispersion simulator into a detector, passing the conditioned aerosol sample through a particle separator, whereby particles of a first size or range at least substantially pass to a first portion of the detector and particles of a second size or range at least substantially pass to a second portion of the detector;
wherein continuously monitoring the quantity of particles of a certain size or range in the conditioned aerosol sample comprises making a plurality of measurements of particles of the first size or range and making a plurality of measurements of particles of the second size or range.

25. The method of claim 16, wherein diluting the aerosol sample with diluent to produce a diluted aerosol sample comprising passing the diluted aerosol sample through a mixing chamber.

26. A monitoring system useable to continuously monitor the emissions from an emissions source, the monitoring system comprising:
(A) sampling means for conducting an aerosol sample from an emissions source;
(B) dilution means for diluting the aerosol sample to form a diluted aerosol sample;
(C) mixing means for mixing the aerosol sample and diluent provided by the dilution means;
(D) ambient dispersion simulator means for transforming the diluted aerosol sample into a conditioned aerosol sample, the conditioned aerosol sample of a form similar to an aerosol formed by the interaction of an emissions plume from the emissions source with the atmosphere, the ambient dispersion simulator means in communication with the mixing means;
(E) detector means for continuously monitoring particulates carried by the conditioned aerosol sample, the detector means in communication with the ambient dispersion simulator means; and
(F) pump means for moving the conditioned aerosol sample through the detector means.

27. The monitoring system of claim 26, wherein the detector means comprises particulate separating means for separating coarse particles in the conditioned aerosol sample from fine particles in the conditioned aerosol sample, whereby the coarse and fine particles are separately measured by the detector means.

28. The monitoring system of claim 26, further comprising particle separating means for separating particles larger than a predetermined size from the aerosol sample, the particle separating means located intermediate to, and in communication with, the mixing means and the sample inlet means.

29. The monitoring system of claim 26, further comprising controller means for reporting data from the detector means and for controlling operational parameters of the monitoring system.

30. The monitoring system of claim 26, further comprising diluent analyzer means for controlling an amount of diluent mixed with the aerosol sample in the mixing means.
